(19) United States
(12) Patent Application Publication
(10) Pub. No.: US 2007/0222278 A1
(43) Pub. Date: Sep. 27, 2007

(54) Wide-low profile tire and a standard hub mounted on a wheel

(75) Inventor: Gary Hoisington, Huntington Beach, CA (US)

Correspondence Address: STETINA BRUNDA GARRED & BRUCKER, 75 ENTERPRISE, SUITE 250, ALISO VIEJO, CA, 92656, US

(73) Assignee: Cycle Support West, Inc. dba Phat Cycles

(21) Appl. No.: 11/390,269

(22) Filed: Mar. 27, 2006

(51) Int. Cl. B60B 21/06

(52) U.S. Cl. 301/58

(57) ABSTRACT

A wheel of a bicycle has a standard or undersized hub mounted on a wide rim using offset spokes in order to correspondingly offset the hub and a rear cog or pulley to one side. The offset hub provides chain or belt clearance between a chain or belt, a tire and a rim edge of the wide rim. An undersized tire may be mounted to the wide rim by providing mirrored inclined surfaces such that tire beads of the undersized tire may ride on the mirrored inclined surfaces and are thereby guided outwardly from a center trough of the wide rim to opposing bead seats of the wide rim during inflation of a tube disposed within the undersized tire.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates generally to bicycle wheels and, more particularly, to a bicycle wheel having a wide-low tire profile wherein an undersized tire and standard hub are mounted on a wide rim.

Conventional bicycle wheels for mountain bikes and road bikes comprise a tire, hub and rim which are sized with respect to each other such that (1) the tire is securely mounted to the rim and (2) bicycle components (e.g., chain, etc.) do not come into contact with the tire and rim during normal operation of the bicycle. For tires that are mounted on a typical clincher-type bicycle rim, the tire width is generally equal to or greater than a width of the rim.

For example, in conventional road clincher-type bicycle rims, a tire having a width of 19 mm to 32 mm (or ⅞ inch to 1⅛ inch) may be mounted on a rim having a width of about 19 mm to about 21 mm. For a touring/hybrid/29-inch diameter clincher-type rim, a tire having a width of 28 mm to 47 mm or (1⅛ inch to 1⅜ inch) may be mounted on a rim having a width of 22 mm to 28 mm. For a mountain bike clincher-type rim, a tire having a width of 1.25 inches to 3 inches may be mounted on a rim having a width of 25 mm to 32 mm. As can be seen, the above-recited rim/tire combinations for clincher-type rims illustrate the conventional practice of mounting a tire onto a rim wherein the tire width which is equal to or greater than the rim width.

Additionally, conventional bicycle wheels hubs are typically attached to the rim such that the wheel may be mounted to the front and rear of the bicycle by securing the rim to a dropout portion of the front forks or to a dropout of the rear of the bicycle frame. Typically, the hub comprises a shell and an axle. Bearings are mounted within the shell and the axle is rotatably supported by the bearings such that the shell may rotate about the axle. Locknuts are threadably secured onto opposite sides of the axle to prevent inadvertent loosening of the axle, bearings and shell. The opposing axle locknuts define a spacing thereacross that is preferably slightly less than the distance between the inner surfaces of the front or rear dropouts such that axle/bearing/shell assembly may be mounted between the dropouts.

The hub may include axle nuts or a quick-release skewer for securing the wheel to the dropouts. In this manner, the wheel is fixedly held to the front forks and/or to the rear portion of the bicycle frame. If the distance between the axle locknuts is much smaller than the distance between the inner surfaces of the dropouts, the front forks or the rear portion of the frame may bend when the axle nuts or quick-release skewer is tightened. Conversely, if the distance between the axle locknuts is greater than the distance between the inner surfaces of the dropouts, the wheel hub cannot be slid between the dropouts.

For both mountain bikes and road bicycles, the rider typically leans or crouches forward in an aggressive position such that the rider may maintain balance on the bicycle. Furthermore, such forward-leaning or crouching body position reduces wind drag generated by the rider. In contrast to mountain and road bike configurations, cruiser type bicycles are configured such that the rider assumes a more upright and relaxed body position. Toward this end, the handlebars are typically positioned rearward in order to facilitate such upright riding position. In addition, cruiser type bicycles typically include a large, padded seat that is attached to the bicycle frame. The large seat is specifically configured to provide greater rider comfort that that which is available using the generally narrow-profile racing-type seats common to mountain and road bicycles.

Furthermore, with cruiser type bicycles, the pedals are typically positioned forward of the seat. The positional relationship of the handlebars, seat and pedals for cruiser type bicycles results in an upright, seated position where comfort is one of the primary goals. Aesthetics is another important goal in the design of cruiser type bicycles wherein the frame of the bicycle is configured with stylish, curvilinear shapes that emulate the styling of a cruiser-type motorcycle. In this regard, the overall configuration of cruiser type bicycles is less concerned with the functional parameters of balance and aerodynamics and instead is more focused on style, image and overall aesthetic qualities.

In furtherance of the styling goals of the cruiser bike, it is desirable to integrate a wide-low profile tire into the cruiser type bicycle frame. Unfortunately, there are two impediments to integrating the wide-low profile tire into the frame of a cruiser type bicycle. First, the widest rim that is currently available on the market is only approximately three inches wide which is not sufficiently wide to emulate the laid-back styling of cruiser-type motorcycles. Furthermore, even if wider rims were commercially available, currently available tires are not capable of being mounted on rims that have a width greater than three inches. The costs associated with manufacturing a tire to fit rims wider than three inches would be prohibitive. Additionally, even if such rims and tires were available in widths greater than three inches, the tire would not have a sufficiently wide-low profile because, as mentioned above, tire widths are generally equal to or greater than the rim width. As such, the tire would have a balloon-shaped profile as is more typical of mountain bike wheels.

Secondly, hubs of conventional rims are typically sized to fit rims having widths of only up to three inches. If a conventional hub were mounted to a rim wider than three inches, the axle locknuts would fall inside of the rim inner periphery. If such a hub were then mounted to the front or rear dropouts, the rim would rub against the front forks or the rear portion of the bicycle frame. Even further, a gear cog mounted to the hub would not sufficiently clear the rim. Additionally, a chain engaged to the rear cog would rub against the rim and/or a tire during rotation of the rear wheel. To overcome the above-described design deficiencies associated with wheels for cruiser type bicycles, a custom hub must be specifically configured and manufactured that is mountable to the bicycle frame such that the axle locknuts, rear cog, and other components sufficiently clear the rim.

Accordingly, there exists a need in the art for an improved bicycle rear wheel that is suitable for use with cruiser type bicycles and which provides the above-mentioned aesthetic qualities desirable in cruiser type bicycles. Furthermore, there exists a need in the art for a bicycle rear wheel for a cruiser type bicycle that is of simple construction and of low cost.

### BRIEF SUMMARY

Disclosed herein is a rear wheel which specifically addresses the above-mentioned shortcomings associated with conventional rear wheels for bicycles. The rear wheel as described herein may have an undersized tire mounted to a relatively wide rim in order to produce a wide-low tire profile when the tire is inflated. To mount the undersized tire to the wide rim, a tube inside the tire is partially inflated and the tube and undersized tire are then mounted on the rim. Tire beads at a perimeter of the opposing tire sidewalls are initially disposed adjacent to a center trough of the wide rim. The tube inside the tire is then inflated to riding pressure.

When the tube is initially inflated with air, the tire beads on opposing sidewalls of the tire are located near a pair of mirrored inclined surfaces on opposing sides of the wide rim. As the tube is further inflated to riding pressure, the tire beads ride up and outwardly onto the mirrored inclined surfaces until the tire beads are engaged to rim beads (i.e., bead seats) on opposing sides of the rim. When the tire beads engage the rim beads, the sidewalls of the undersized tire may bulge outwardly beyond the rim beads on opposing side of the rim. In addition, the outward bulging of the tire causes the tread of the undersized tire to assume a reduced height or lowered profile than in the under-inflated state. As a result, the tire assumes a wide-low profile when mounted on the wide rim of the rear wheel.

Although the tire and wide rim may be provided in any size, the relative dimensions thereof in the non-inflated or under-inflated states are preferably such that the tire assumes the wide-low profile when in the fully inflated state. For example, the undersized tire may be a standard off-the-shelf three (3) inch wide tire. The wide rim may be about 3¼ inch to about 4 inches wide. When the tire sidewalls bulge outward and the tread profile is reduced or lowered due to pressurization of the tube, the rear wheel assumes the wide-low tire profile.

In another aspect of the rear wheel, a standard hub may be mounted to the wide rim. The standard hub is preferably offset to the right of center of the wide rim such that a rear cog attached to the standard hub provides clearance for a chain engaged to the rear cog as well as to provide clearance between the chain and the rim edge or undersized tire. The standard hub is preferably offset to the right by providing a plurality of spokes holes extending through the rim and which are offset from the rim centerline.

### BRIEF DESCRIPTION OF THE DRAWINGS

These and other features and advantages of the various embodiments disclosed herein will be better understood with respect to the following description and drawings in which like numbers refer to like parts throughout and in which:

FIG. 1 is a side view of a bicycle;

FIG. 2 is an enlarged side view of a rear wheel of the bicycle of FIG. 1;

FIG. 3 is a cross sectional view of a wide rim of the rear wheel shown in FIG. 2 illustrating an offset pattern of spoke holes for offset mounting of a standard hub;

FIG. 4 is a cross sectional view of the rear wheel of FIG. 2 wherein a tube of the rear wheel is deflated and tire beads of an undersized tire are disposed adjacent a center trough of the wide rim;

FIG. 5 is a cross sectional view of the rear wheel wherein the tire beads are disposed on mirrored inclined surfaces when the tube is at least partially inflated;

FIG. 6 is a cross sectional view of the rear wheel showing the tire beads seated onto rim beads (i.e., bead seats) of the wide rim; and

FIG. 7 is a cross sectional view of an alternative embodiment of the wide rim having mirrored inclined surfaces that are stepped above the center trough;

FIG. 8 is a top view of the rear wheel, rear cog and front chain ring of FIG. 1 illustrating a chain clearance between a tire/rim edge and chain; and

FIG. 9 is a cross sectional view of the wide rim of the rear wheel shown in FIG. 2 except that a rear cog shown in FIG. 2 is replaced with a rear pulley and a belt.

### DETAILED DESCRIPTION

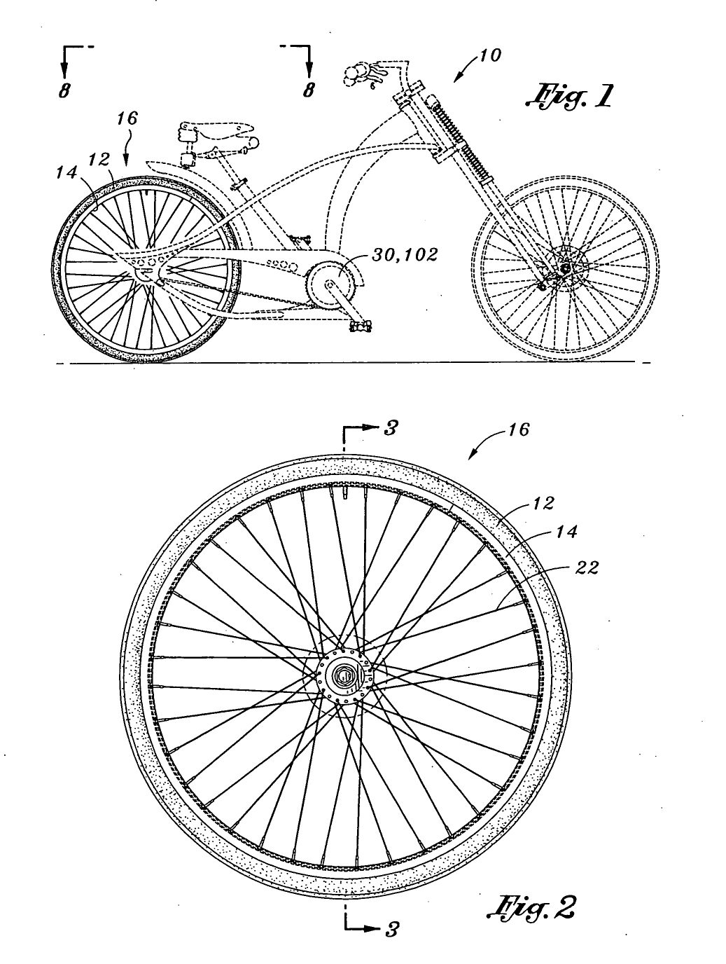

Referring now to the drawings wherein the showings are for purposes of illustrating preferred embodiments of the present invention and not for purposes of limiting the same, FIG. 1 is a side view of a cruiser type bicycle 10 having an undersized tire 12 mounted to a wide rim 14 for creating a wide-low tire profile in a rear wheel 16. The undersized tires 12 and standard hubs 18 such as those shown in FIG. 3 may be mounted to the wide rim 14 and are preferably standard, off-the-shelf products in order to minimize costs of the wheel assembly (i.e., wide rim 14, undersized tire 12, and standard hub 18).

It should also be noted that the wheel described herein is in reference to the rear wheel 16. However, the drawings and description of the wheel 16 are not to be construed as limiting the embodiments disclosed herein to rear wheels 16. As such, the various aspects of the present invention may also be embodied in other wheel configurations such as in front wheels of bicycles, tricycle wheels, and the like. Also, the specific sizes and proportions of the undersized tires 12, wide rims 14 and standard hubs 18 mentioned herein are for purposes of illustrating various aspects of the present invention and are not meant to limit the present invention to those specific sizes and proportions listed herein. In this regard, it is contemplated that the various aspects of the present invention may be employed in wheels having other sizes and proportions.

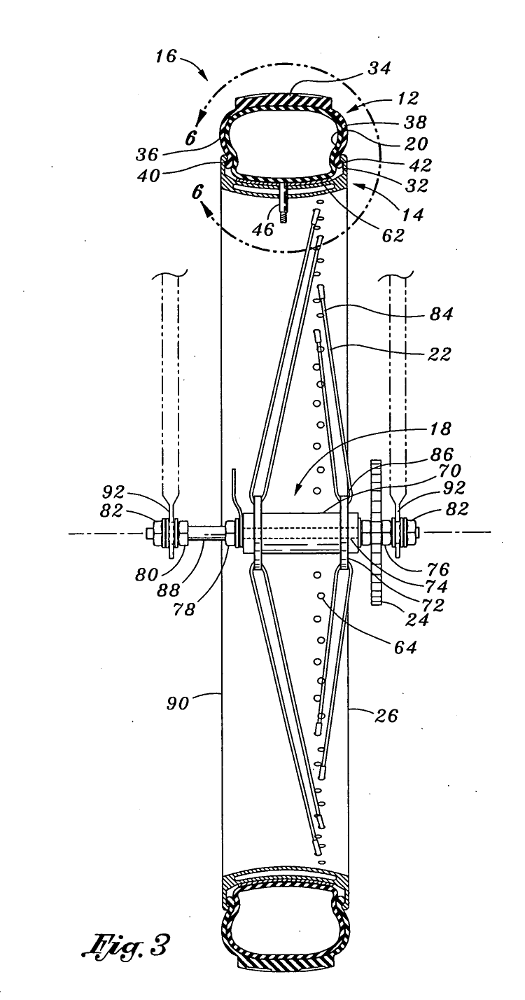

Referring now to FIGS. 2 and 3, shown is an enlarged side view of the rear wheel 16 of the bicycle 10. The rear wheel 16 may comprise an undersized tire 12, a wide rim 14, an inflatable tube 20, a plurality of spokes 22, and a standard hub 18. FIG. 3 is a cross sectional view of the rear wheel 16 shown in FIG. 2 illustrating the assembly of the undersized tire 12, wide rim 14, tube 20, spokes 22, and standard hub 18 in a manner such that an undersized tire 12 may be mounted to the wide rim 14.

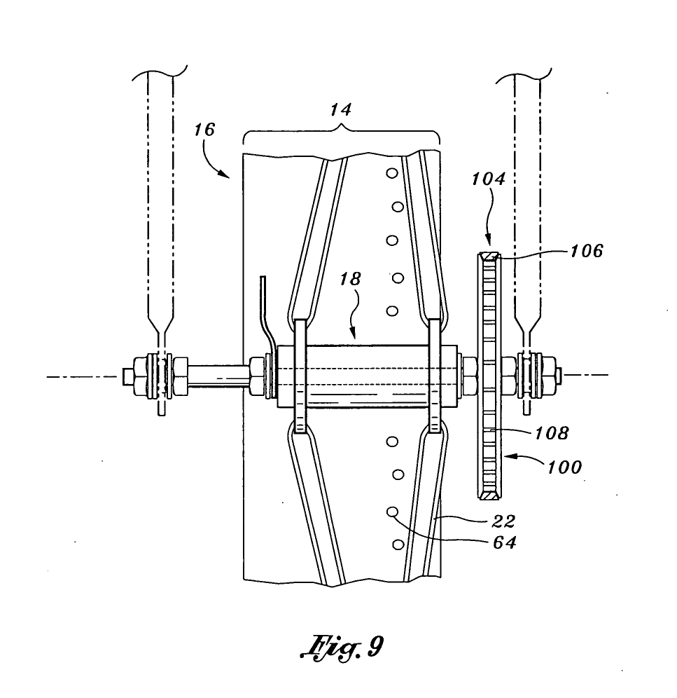

Due to the relative geometries of the undersized tire 12 and wide rim 14, the wheel assumes a wide-low tire profile after tube 20 inflation. Also, FIG. 3 illustrates a rear cog 24 attached to a right side of the standard hub 18 and being attached thereto such that the chain clears a right outer rim edge boundary 26 of the wide rim 14. In this regard, the chain 28 (see FIG. 8) may be engaged to the rear cog 24 and a front chain ring 30 in a manner such that the chain 28 does not contact or rub against a right vertical sidewall 32 (see FIG. 3) of the wide rim 14 or of the undersized tire 12 (see FIG. 8).

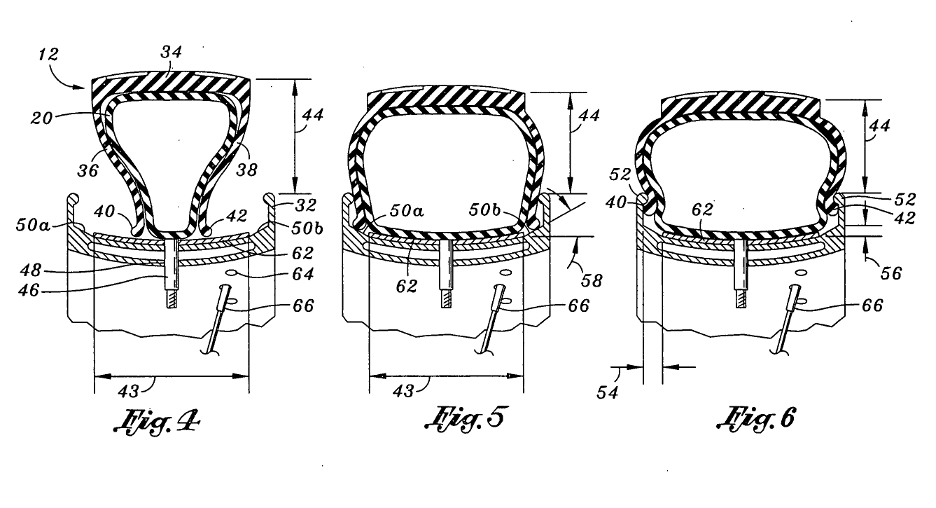

The undersized tire 12 may define a tread 34, left and right sidewalls 36, 38, and left and right tire beads 40, 42, as shown in FIGS. 3 and 4. An outer peripheral portion of the undersized tire 12 may define the tread 34 and may be characterized as the main portion of the undersized tire 12 that directly interfaces with the surface or ground upon which the wheel rests or along which the wheel rolls. The tread 34 may be designed to grip the ground over which the bicycle 10 is ridden such that the rear wheel 16 does not lose traction or slip out from under the rider. In addition, the outer surface of the tread 34 may be configured to have a V-shaped tread pattern in order to spread water away from the undersized tire 12 to avoid hydroplaning.

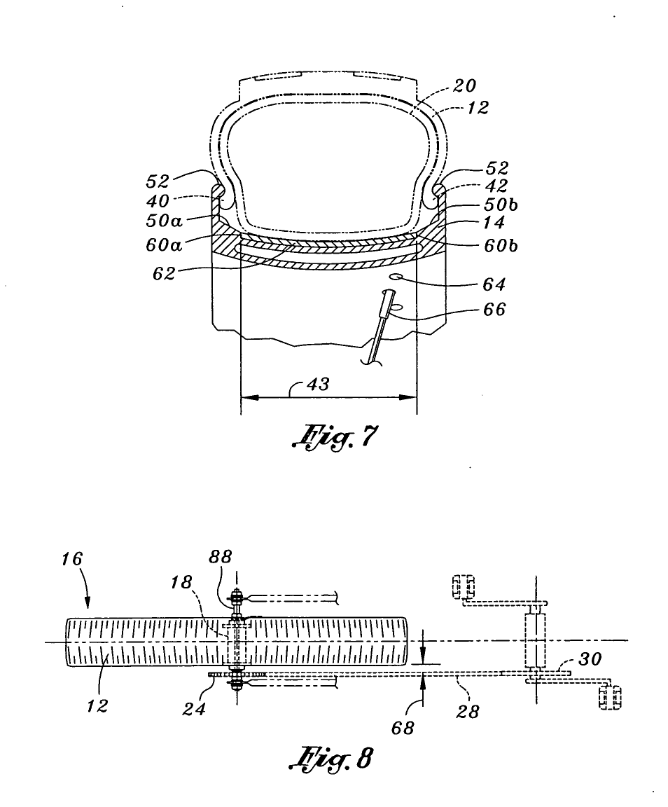

Also, the tread 34 may includes knobs to provide enhanced grip on dirt or gravel surfaces. Furthermore, the tread 34 may be sufficiently thick to protect the tube 20 disposed within the undersized tire 12 from thorns and other sharp objects and to extend the useful life of the undersized tire 12. Typically, the tread 34 is thicker and less flexible compared to the sidewalls 36, 38. As a result, as the tube 20 is inflated, the sidewalls 36, 38 tend to bulge outward as can be seen in FIG. 6.

The left and right sidewalls 36, 38 are disposed on opposed sides of the tread 34, as shown in FIG. 3. The sidewalls 36, 38 are radially inwardly directed about the entire periphery of the tread 34. The left and right tire beads 40, 42 are formed on inner peripheries of the sidewalls 36, 38. The left sidewall 36 and left tire bead 40 may have a mirror configuration of the right sidewall 38 and the right tire bead 42. The sidewalls 36, 38 and the tire beads 40, 42 may curve toward each other when the tire is under-inflated or non-inflated as shown FIG. 4.

When the tube 20 is installed within the undersized tire 12 and mounted on the wide rim 14, the tire beads 40, 42 and the sidewalls 36, 38 are initially disposed within a center trough 43 of the wide rim 14. As the tube 20 is inflated, the tire beads 40, 42 engage rim beads 52 of the wide rim 14. When the tube 20 is further inflated such as to riding pressure, the sidewalls 36, 38 bulge outwardly from edges of the wide rim 14. The outward bulging of the tire causes the tread 34 height to be reduced or to be lowered closer toward the wide rim 14 as is sequentially shown in FIGS. 4 through 6. The engagement of the tire beads 40, 42 to the rim beads 52 prevents slippage of the undersized tire 12 off of the wide rim 14 as the tube 20 is inflated as well as during riding of the bicycle 10.

During installation of the undersized tire 12 to the wide rim 14, the tube 20 may be partially inflated. The partially inflated tube 20 may then be inserted between the left and right sidewalls 36, 38 of the undersized tire 12. The left tire sidewall 36 may then be urged over the right vertical sidewall 32 of the wide rim 14. A valve stem 46 of the tube 20 may be inserted into a valve hole 48 formed in the center trough 43. The right tire sidewall 38 may then be urged over the right vertical sidewall 32 of the wide rim 14. At this point, the undersized tire 12 and the tube 20 are generally located in the center trough 43 as shown in FIG. 4. A check may be performed to ensure that the tube 20 and the undersized tire 12 are properly seated about the center trough 43 of the wide rim 14 by squeezing the tire sidewalls 36, 38 and checking the tube 20. An air pump may be attached to the valve stem 46 in order to pump air into the inflatable tube 20 wherein the tube 20 may be inflated to riding pressure.

FIGS. 4-6 illustrate the orientations of the tube 20, undersized tire 12 and wide rim 14 as the tube 20 is inflated to riding pressure. In FIG. 4, the tube 20 is non-inflated or partially inflated to facilitate installation of the tube 20 and undersized tire 12 over the wide rim 14, as discussed above. The tire beads 40, 42 and tire side walls 36, 38 are generally disposed about the rim center trough 43. As the tube 20 is further inflated, the tire beads 40, 42 engage mirrored inclined surfaces 50a, 50b, as shown in FIG. 5.

When the tube 20 is inflated to riding pressure, the tire beads 40, 42 engage the rim beads 52. In this condition, tire sidewalls 36, 38 may tend to bulge outwardly while the tread 34 height is reduced relative to the wide rim 14. In this manner, the rear wheel 16 has a wide-low profile. The mirrored inclined surfaces 50a, 50b guide the tire beads 40, 42 in a generally uniform manner from the center trough 43 toward the rim beads 52. A shown in FIG. 6, the center trough 43 may have a run length 54 of about 7/16 inch and a rise height 56 of about 3/16 inches. As shown in FIG. 5, the inclined surface 50 may have an angle 58 of up to about 25 degrees with respect to a rotating axis of the rear wheel 16.

Optionally, the wide rim 14 may be formed with left and right rim humps 60a, 60b, as shown in FIG. 7. The left rim hump 60a may be interposed between the left inclined surface 50a and the center trough 43. The right rim hump 60b may be interposed between the right inclined surface 50a, 50b and the center trough 43. The rim humps 60a, 60b offset the mirrored inclined surfaces 50a, 50b from one another in an upward direction from the center trough 43. The upward offset provides an additional mechanism by which the tire beads 40, 42 are urged along the mirrored inclined surfaces 50a, 50b from the center trough 43 toward the rim beads 52 (i.e., bead seats) of the wide rim 14 as the tube 20 is inflated to riding pressure. In this manner, the mirrored incline surfaces 50a, 50b facilitates the mounting of the undersized tire 12 on the wide rim 14. By way of example and not limitation, the wide rim 14 may have a width of about 3¼ inches to about 4 inches and a diameter of about 20¾ inches. The undersized tire 12 may be a 24×3.0 tire manufactured by Kenda.

The wheel may include a rim strip 62 disposed about the center trough 43 and which is preferably configured to cover the spoke holes 64 formed through the center trough 43. The rim strip 62 is configured to protect the tube 20 when inflated against sharp surfaces that may protrude into and puncture the tube 20. For example, spoke nipples 66 extending through the spoke holes 64 may have sharp corners which may puncture the tube 20 upon direct contact with the tube 20. To assist in the mounting of the tube 20 within the undersized tire 12, the tube 20 and inner surfaces of the undersized tire 12 may be coated with talcum powder to facilitate positioning of the tube 20 within the undersized tire 12. By this manner, the tube 20 is less likely to be twisted or pinched between the tire beads 40, 42 which may result in rupturing of the tube 20 over time.

In another aspect of the wheel, the rear wheel 16 may include a standard hub 18 having an undersized shell 70 and an elongate axle 74, as shown in FIGS. 3 and 8. For example, standard off the shelf hubs available from Shimano, KT, Sachs, and Bendix may be mounted on the rear wheel 16. To accommodate the standard hub 18, the same is preferably offset to the right of the center of the wide rim 14 as shown in FIG. 3 in order to provide chain clearance 68 between a chain 28 and the undersized tire/wide rim 12, 14 as is best seen in FIG. 8.

Such offset mounting of the hub may be facilitated by providing a plurality of spoke holes 64 in the center trough 43 of the wide rim 14 for receiving spoke nipples 66. The spoke holes 64 are preferably offset to the right of the wide rim 14 centerline by about three quarters of a width, as shown in FIG. 3. The spoke nipples 66 are typically received into the spoke holes 64 and are engaged to the spoke nipples 66 which are, in turn, engaged to the standard hub 18. More particularly, the standard hub 18 may comprise the shell 70 which may include a flange 72, an elongate axle 74, first, second and third axle locknuts 76, 78, 80, axle nuts 82 or a quick release skewer, and a rear cog 24.

The spokes 22 may be attached to the flange 72 of the hub shell 70 via the flange 72 which extends about the hub shell 70. The standard hub 18 is, in turn, connected to the wide rim 14 via the spokes 22 in a conventional manner except that the standard hub 18 is offset to the right of wide rim 14 centerline. The standard hub 18 is sufficiently offset to the right of a center of the wide rim 14 such that the rear cog 24 clears the right outer rim edge boundary 26 of the wide rim 14. In this manner, when a chain 28 is attached to the rear cog 24, the chain 28 does not rub against the wide rim 14 or the undersized tire 12.

To offset the standard hub 18 to the right side of the wide rim 14, the spoke holes 64 are also offset from a middle portion of the center trough 43, as shown in FIG. 3. The spoke holes 64 are sufficiently offset to the right of the middle portion such that the rear cog 24 clears the right outer rim edge boundary 26. Also, when a chain 28 is engaged to the rear cog 24 and the front chain ring 30, the chain 28 clears the undersized tire 12 and wide rim 14 of the rear wheel 16, as shown in FIG. 8. In other words, the chain 28 does not contact the undersized tire 12 or wide rim 14 while the rider is riding the bicycle 10.

The pattern of spoke holes 64 are preferably formed on a right side of the center trough 43 and are extended through the inner peripheral surface of the wide rim 14. The spoke nipples 66 are inserted into the spoke holes 64 through the center trough 43. A first distal end 84 of each of the spokes 22 may be inserted into apertures formed in a flange 72 of the shell 70 of the standard hub 18. A nub is formed on the second distal end 86 of the spokes 22 to retain the spokes 22 on the flange 72. The spoke nipples 66 may be threadably engaged to the first distal ends 84 of the spokes 22. The spoke nipples 66 may be rotated as desired in order to tighten or loosen the spokes 22 for truing the wide rim 14 and such that the standard hub 18 is sturdily held to the wide rim 14.

The shell 70 of the standard hub 18 may have a hollow center. Bearings may be disposed on opposed sides of the shell 70. An elongate axle 74 may be disposed within the shell 70 and may be rotatably supported on the bearing such that the axle 74 rotates relative to the shell 70. The first and second axle locknuts 76, 78 may be tightened in such a manner as to rotatably fix the bearings, elongate axle 74 and the shell 70 together.

As was earlier mentioned, the rear cog 24 may be attached to a right side of the standard hub 18 to drive the rear wheel 16 forward. The left side of the elongate axle 74 may have a spacer 88 that fits over the elongate axle 74 and a third axle locknut 80 that tightens the spacer 88 on the elongate axle 74. The elongate axle 74 is preferably of sufficient length such that the third left axle nut 82 clears a left outer rim edge boundary 90. The spacer 88 is also preferably of sufficient length such that a distance between the third axle locknut 80 and the first (i.e., right) axle locknut 76 is slightly less than a distance between inner surfaces of rear dropouts 92 of the bicycle 10 frame.

To mount the rear wheel 16 to the frame of the bicycle 10, the axle 74 may be received into rear dropouts 92. The third (i.e., left) axle locknut 80 and the first (i.e., right) axle locknut 76 are preferably sized so as to snugly fit between the rear dropouts 92 as is illustrated in FIG. 3. A quick-release skewer may be inserted through a bore formed in the elongate axle 74 in order to tighten the rear wheel 16 onto the rear dropouts 92. Alternatively, axle nuts 82 may be threadably engaged to the axle 74 to allows attachment of the rear wheel 16 onto the rear dropouts 92.

In another aspect of the rear wheel 16, although the rear wheel 16 is described as having a rear cog 24 and a chain 28 driving the rear cog 24 and front chain ring 30, it is also contemplated that the various aspects of the rear wheel 16 may be employed and embodied in conjunction with a rear pulley 100, front pulley 102 (see FIG. 1) and a belt 104 for driving the front and rear pulleys 100, 102, as shown in FIG. 9. By way of example and not limitation, the front pulley 102, rear pulley 100 and belt 104 respectively may replace the front chain ring 30, rear cog 24 and chain 28 discussed above. The hub 18, spokes 22 and spoke holes 64 as well as other components may be offset as discussed above in relation to the rear cog 24, front chain ring 30 and chain 28 to accommodate the standard hub 18. In this manner, the standard hub 18 is also offset to the right. As such, when the rear pulley 100 is mounted to the standard hub 18 and the belt 104 is mounted to the rear pulley 100 and front pulley 102, there is belt clearance between the belt 104 and the undersized tire/wide rim 12, 14.

FIG. 9 illustrates the rear pulley 100 and the belt 104 engaged to the rear pulley 100. The belt 104 may also engage the front pulley 102. The front pulley 102 transfers a driving force to the rear pulley 100 and ultimately to the rear wheel 16 via the belt 104. In particular, the front and rear pulleys 102, 100 may have inner teethes 106 for engaging outer teethes 108 of the front and rear pulleys 102, 100. The teethes 106, 108 prevent the belt 104 from slipping on the front and rear pulleys 102, 100. Alternatively, the front and rear pulleys 102, 100 may be a variable belt drive system which receives a V type belt. Friction prevents the belt 104 from slipping on the front and rear pulleys 102, 100. Further, the front and/or rear pulleys 102, 100 may be brought closer together or spread apart to vary a pulley ratio between the front and rear pulleys 102, 100 for varying the speed of the bicycle 10.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A bicycle wheel having a wide-low profile tire, the wheel comprising:
a) a rim defining first and second bead seats, first and second side walls, a central trough and a width, the rim having first and second inclined surfaces, the first inclined surface being disposed between the first side wall and the central trough, the second inclined surface being a mirror image configuration of the first inclined surface and being interposed between the second side wall and the central trough, the bead seats being disposed at outer peripheries of the first and second side walls;
b) a tire being undersized with respect to a width of the rim and being disposed about the rim, the tire defining a tire width and having treads, first and second sidewalls, and first and second tire beads, the first sidewall being interposed between the treads and the first tire bead, the second sidewall being interposed between the treads and the second tire bead; and
c) an inflatable tube disposed within the tire;
d) wherein the tire beads are configured to rest within the central trough when the tube is deflated and being further configured to be guided up the mirrored inclined surfaces to the bead seats as the tube is inflated.

2. The wheel of claim 1 further comprising rim humps offsetting the mirrored inclined surfaces above the central trough.

3. The wheel of claim 1 wherein the tire width is about three inches and the rim width is about four inches.

4. The wheel of claim wherein the tire width is about two or more sizes smaller as compared to the rim width.

5. The wheel of claim 1 wherein:
the rim width for road clinchers is between about 19-21 mm and the tire width is less than about 19 mm;
the rim width for touring/hydrid/29″ clinchers is between about 22 and 28 mm and the tire width is less than about 28 mm;
the rim width for mountain bike clinchers is between about 25-32 mm and the tire width is less than about 1¼ inch;
the rim width for tubular rims is between about 19 and 21 mm and the tire width is less than about 18 mm.

6. The wheel of claim 1 wherein the inclined surface has an angle of up to about 25 degrees with respect to a rotating axis of the rear wheel.

7. The wheel of claim 1 wherein the inclined surface has a rise of about 3/16 inches and a run length of about 7/16 inches with respect to the rim width.

8. A wheel for a bicycle having a front chain ring, a rear cog and a chain connecting the front chain ring to the rear cog, the wheel comprising:
a) a hub defining a width and having a shell;
b) a plurality of spokes attached to the shell;
c) a rim having a cog side rim edge, a center trough and a width, the rim width being oversized with respect to the hub width, the rim having an offset pattern of spoke holes formed through the center trough, the plurality of spokes being attached to the rim at the offset pattern of spoke holes such that the hub is offset in a manner to provide chain clearance between the chain and the cog side rim edge; and
d) an axle defining a length wherein the length is sized complementary to the rim width.

9. The wheel of claim 8 wherein:
the rim width is about 3.25 inches to about 4 inches;
the hub being sized and configured to fit a rim having a width no greater than about 3 inches;
the axle having a length that is sized and configured to fit a rim having a width of at least about 3.25 inches.

10. A wheel for a bicycle having a front pulley, a rear pulley and a belt connecting the front pulley to the rear pulley, the wheel comprising:
a) a hub defining a width and having a shell;
b) a plurality of spokes attached to the shell;
c) a rim having a pulley side rim edge, a center trough and a width, the rim width being oversized with respect to the hub width, the rim having an offset pattern of spoke holes formed through the center trough, the plurality of spokes being attached to the rim at the offset pattern of spoke holes such that the hub is offset in a manner to provide belt clearance between the belt and the pulley side rim edge; and
d) an axle defining a length wherein the length is sized complementary to the rim width.
